(19) United States
(12) Patent Application Publication
(10) Pub. No.: US 2019/0257068 A1
(43) Pub. Date: Aug. 22, 2019

(54) A SYSTEM FOR ENVIRONMENTAL SPILLS PROTECTION

(71) Applicant: WATERUP PTY LTD, Lakesland (AU)

(72) Inventor: Justin Conway, Lakesland, New South Wales (AU)

(21) Appl. No.: 15/545,773

(22) PCT Filed: Jan. 23, 2015
(86) PCT No.: PCT/AU2015/000035

§ 371 Date: Jul. 24, 2017

(51) Int. Cl. E03F 5/10; C02F 1/00

(52) U.S. Cl. CPC E03F 5/101; C02F 2103/007; E03F 5/107; C02F 1/008

(57) ABSTRACT

The present invention relates to a system and method for containing environmental spills at a zone, for example at a port or rail facility, in order to prevent nm-off water from contaminating the environment. The system and method relates to a water parameter sensor system which is compared to stored contaminants to establish the nature of the contaminant. The system and method further relates to the comparison of the identified contaminant to a manifest database to be able to establish where a spill or leakage may be found.

### FIELD OF THE INVENTION

The present invention relates to environmental control systems, environmental protection systems and in particular to a system for protecting a zone from environmental spills and/or leakages.

The invention has been developed primarily for use in/with controlling the discharge of drainage and stormwater into the environment and will be described hereinafter with reference to this application. However, it will be appreciated that the invention is not limited to this particular field of use.

### BACKGROUND

Drainage and stormwater is today often times simply trapped and released into the environment. However, these existing arrangements suffer from the potential for the release of harmful toxins or chemicals into the environment.

In one application, contaminant may be released from ports into the environment. Specifically, ports usually comprise gross pollutant traps which collect waste water for release to the environment, such as adjoining estuaries and the like, drainage and stormwater.

However, shipping containers, many containing dangerous contaminants, move through the port and often times leak their contents. Such leakage may be collected by the gross pollutant traps and released into the environment.

According to existing arrangements, these contaminants may be released into the environment undetected causing great damage to the environment in certain instances.

As such, a need therefore exists for a system to substantially reduce or prevent the discharge of contaminants into the environment.

Furthermore, in the event of a toxic chemical spill or the like, is often indeterminate as to the nature or volumetric amount of contaminant but has been released into the environment. Such information is vital when it comes to clean up operations. Further, time may be of the essence in management of such cleanup operations, as operations at a port may need to be shut down while the cleanup happens.

It is to be understood that, if any prior art information is referred to herein, such reference does not constitute an admission that the information forms part of the common general knowledge in the art, in Australia or any other country.

### SUMMARY

According to one aspect, there is provided a system for environmental spills protection, the system comprising a discharge valve; a controller operably coupled to the discharge valve, the controller able to control the discharge valve in use; at least one water quality sensor operably coupled to the controller, the at least one water quality sensor being able to make a water quality parameter measurement of a water quality parameter at an input of the discharge valve, and, wherein, in use, the controller is adapted to control the discharge valve in accordance with the water quality parameter measurement.

The system is able to automate the process of a sampling waste water and only should the waste water meets certain water quality requirements release the waste water into the environment. In this manner, the inadvertent release of toxins, chemicals and the like may be reduced or eliminated altogether.

The water quality parameter may comprise at least one of pH, electrical conductivity/total dissolved solids, oxidation and reduction potential, turbidity, temperature, dissolved oxygen, total petrol hydrocarbons water quality parameter measurements. In one embodiment, the water quality sensor comprises a spectrophotometer to provide greater resolution in measurement.

In this manner, the system may measure many differing types of parameters for the purposes of determining whether the waste water meets the water quality requirements.

The water quality sensor limit of detection for the pH quality parameter may be substantially pH 0-14. The water quality sensor limit of detection for the electrical conductivity/total dissolved solids quality parameter may be substantially 0.1 uS to 500 mS/cm (mS). The water quality sensor limit of detection for the oxidation and reduction potential quality parameter may be substantially −2000 to +2000 mV. The water quality sensor limit of detection for the turbidity quality parameter may be substantially 0.001 to 100 NTU. The water quality sensor limit of detection for the temperature quality parameter may be substantially 0.001 to 100 NTU. The water quality sensor limit of detection for the dissolved oxygen quality parameter is substantially 5 to 80° C. The water quality sensor limit of detection for the total petrol hydrocarbons may be substantially 0.1 to 2000 ppb.

The controller may be further adapted to control the discharge valve in accordance with a plurality of successive water quality parameter measurements.

In this manner, the controller may reduce the error during the measurement process. For example, the controller may be adapted to utilise three successive water quality parameter measurements and only if all three of these successive water quality parameters indicate that the waste water meets the water quality requirements, release the waste water into the environment.

The controller may be adapted to identify at least one contaminant in accordance with the water quality parameter measurement.

By identifying a potential contaminants in the waste water, appropriate action may be taken including by the controller, and in alerting relevant authorities and the like if required.

The system is configured such that the default position of the discharge valve is closed.

By keeping the valve and the default position, the system guards against system failure and the potentially ensuing inadvertent release of toxic waste water into the environment.

The controller may be adapted to open the discharge valve upon determining the absence of at least one contaminant.

The controller may be further configured to control the discharge valve to discharge a predetermined volume of water.

In this manner, should a contaminant be inadvertently released into the environment, the volumetric amount of the contaminant released into the environment may be known. Such information may be useful for cleanup operations and the like.

The system may further comprise a buffer tank fluidly coupled to an input of the discharge valve and wherein, in use, the controller is further configured to controlled the discharge valve to substantially discharge the contents of the buffer tank.

The buffer tank may be utilised for the purposes of storing a set volume of waste water for sampling and released by the controller.

The at least one water quality sensor may be a plurality of water quality sensors each respectively able to sense a plurality of water quality parameter measurements and wherein, in use, the controller is adapted to identify the at least one contaminant in accordance with the plurality of water quality parameter measurements.

In this manner, by utilising a plurality of water quality measurements, the controller is able to identify at least one contaminant in accordance with a contaminant “fingerprint”.

If the contaminant comprises water-based paint the water quality parameter measurements may comprise at least one of turbidity, electrical conductivity/total dissolved solids and dissolved oxygen.

If the contaminant comprises oil-based paint, the water quality parameter measurements may comprise at least one of turbidity, total petrol hydrocarbons and electrical conductivity/total dissolved solids.

If the contaminant comprises volatiles (hydrocarbons/solvents), the water quality parameter measurements may comprise at least one of total petrol hydrocarbons, oxidation and reduction potential, electrical conductivity/total dissolved solids and dissolved oxygen.

If the contaminant comprises soluble powders, the water quality parameter measurements may comprise at least one of turbidity, pH and electrical conductivity/total dissolved solids.

If the contaminant comprises insoluble powders, the water quality parameter measurements may comprise at least one of turbidity.

The system may further comprise a manifest database comprising manifest data operably coupled to the controller and wherein, in use, the controller is adapted to further identify the at least one contaminant in accordance with the manifest data.

In this manner, by leveraging off a no manifest, the control is able to obtain a far greater accuracy when identifying a potential contaminant. Furthermore, by utilising the manifest database, the exact location of the source of contaminant may be ascertained quickly.

The system may further comprise a fluid pressure sensor operably coupled to the controller and wherein, in use, the fluid pressure sensor is adapted to measure a fluid pressure at an inlet of the discharge valve.

In this manner, the controller may control the discharge valve in accordance with demand requirements,

The system may further comprise a rain sensor operably coupled to the controller and wherein, in use, the rain sensor is adapted to measure a rainfall amount.

In this manner, the system may increase the rate of discharge from the discharge valve in anticipation of the arrival of a flood of stormwater.

In another aspect, the invention may be said to consist in a system for environmental spills protection, the system comprising:
a. a discharge valve;
b. a controller operably coupled to the discharge valve, the controller able to control the discharge valve in use;
c. at least one water quality sensor operably coupled to the controller, the at least one water quality sensor being able to make a water quality parameter measurement of a water quality parameter at an input of the discharge valve, and, wherein, in use, the controller is adapted to control the discharge valve in accordance with the water quality parameter measurement.

In one embodiment, the water quality parameter comprises at least one of pH, electrical conductivity/total dissolved solids, oxidation and reduction potential, turbidity, temperature, dissolved oxygen, total petrol hydrocarbons water quality parameter measurements.

In one embodiment, the water quality sensor limit of detection for the pH quality parameter is substantially pH 0-14.

In one embodiment, the water quality sensor limit of detection for the electrical conductivity/total dissolved solids quality parameter is substantially 0.1 uS to 500 mS/cm (mS).

In one embodiment, the water quality sensor limit of detection for the oxidation and reduction potential quality parameter is substantially −2000 to +2000 mV

In one embodiment, the water quality sensor limit of detection for the turbidity quality parameter is substantially 0.001 to 100 NTU.

In one embodiment, the water quality sensor limit of detection for the temperature quality parameter is substantially 0.001 to 100 NTU

In one embodiment, the water quality sensor limit of detection for the dissolved oxygen quality parameter is substantially 5 to 80° C.

In one embodiment, the water quality sensor limit of detection for the total petrol hydrocarbons is substantially 0.1 to 2000 (ppb)

In one embodiment, the the controller is further adapted to control the discharge valve in accordance with a plurality of successive water quality parameter measurements.

In one embodiment, the controller is adapted to identify at least one contaminant in accordance with the water quality parameter measurement.

In one embodiment, the system is configured such that the default position of the discharge valve is closed.

In one embodiment, the controller is adapted to open the discharge valve upon determining the absence of at least one contaminant.

In one embodiment, in use, the controller is further configured to control the discharge valve to discharge a predetermined volume of water.

In one embodiment, the system further comprises a buffer tank fluidly coupled to an input of the discharge valve and wherein, in use, the controller is further configured to controlled the discharge valve to substantially discharge the contents of the buffer tank.

In one embodiment, the the at least one water quality sensor is a plurality of water quality sensors each respectively able to sense a plurality of water quality parameter measurements and wherein, in use, the controller is adapted to identify the at least one contaminant in accordance with the plurality of water quality parameter measurements.

In one embodiment, the contaminant comprises water-based paint.

In one embodiment, the water quality parameter measurements comprise at least one of turbidity, electrical conductivity/total dissolved solids and dissolved oxygen.

In one embodiment, the contaminant comprises oil-based paint.

In one embodiment, the water quality parameter measurements comprise at least one of turbidity, total petrol hydrocarbons and electrical conductivity/total dissolved solids.

In one embodiment, the contaminant comprises volatiles (hydrocarbons/solvents).

In one embodiment, the water quality parameter measurements comprise at least one of total petrol hydrocarbons, oxidation and reduction potential, electrical conductivity/total dissolved solids and dissolved oxygen.

In one embodiment, the the contaminant comprises soluble powders.

In one embodiment, the the water quality parameter measurements comprise at least one of turbidity, pH and electrical conductivity/total dissolved solids.

In one embodiment, the contaminant comprises insoluble powders.

In one embodiment, the water quality parameter measurements comprise at least one of turbidity.

In one embodiment, the system further comprises a manifest database comprising manifest data operably coupled to the controller and wherein, in use, the controller is adapted to further identify the at least one contaminant in accordance with the manifest data.

In one embodiment, the system further comprises a fluid pressure sensor operably coupled to the controller and wherein, in use, the fluid pressure sensor is adapted to measure a fluid pressure at an inlet of the discharge valve.

In one embodiment, the controller is adapted to control the discharge in accordance with the fluid pressure.

In one embodiment, the system further comprises a rain sensor operably coupled to the controller and wherein, in use, the rain sensor is adapted to measure a rainfall amount.

In one embodiment, the controller is adapted to control the discharge in accordance with the fluid pressure.

In another aspect, the invention may be said to consist in an environmental protection system for detecting environmental spills and/or leakages at a zone, the system comprising:
a. a tank configured for storing water run-off from the zone;
b. a controller comprising
   1. a transmitter for transmitting signals,
   2. a receiver configured receiving signals,
   3. digital media for storing control instructions, and
   4. a processor for processing the control instructions;
c. wherein the controller is configured for receiving signals indicative of water quality parameter measurements from at least one or more water quality sensors, the water quality sensors able to make a water quality parameter measurement of a water quality parameter;
d. wherein, in use, the controller is adapted to identify at least one contaminant in accordance with the water quality parameter measurement. C

In one embodiment, the system further comprises a discharge valve.

In one embodiment, the controller is adapted to control the discharge valve in accordance with the water quality parameter measurement.

In one embodiment, the system further comprises at least one or more water quality sensors operably coupled to the controller, the at least one water quality sensor being able to make a water quality parameter measurement of a water quality parameter.

In one embodiment, the at least one water quality sensor is a plurality of water quality sensors each respectively able to sense a plurality of water quality parameter measurements and wherein, in use, the controller is adapted to identify the at least one contaminant in accordance with the plurality of water quality parameter measurements.

In one embodiment, the controller is adapted to compare the water quality parameters measured by the at least one or more water quality sensors to a contaminants database of water quality parameters associated with known contaminants.

In one embodiment, the control is adapted to identify at least one or more possible contaminants matching the water quality parameters measurements received from the sensors from the comparison of the water quality parameters with the contaminants database.

In one embodiment, the system further comprises a contaminants database of stored contaminants associated with known water quality parameters or ranges of water quality parameters.

In one embodiment, the controller is adapted to actuate an alarm signal in accordance with the comparison.

In one embodiment, the alarm signal includes an indication of the identified contaminant.

In one embodiment, the at least one or more sensors are configured for detecting water quality parameters including at least one or more selected from pH, electrical conductivity/total dissolved solids, oxidation and reduction potential, turbidity, temperature, dissolved oxygen, total petrol hydrocarbons water quality parameter measurements.

In one embodiment, the controller is adapted to control the discharge valve in accordance with the comparison of the water quality parameters with the contaminants database.

In one embodiment, the controller is adapted to compare the one or more identified contaminants with a manifest database of current and/or past potential contaminants that have been stored in or moved through the zone.

In one embodiment, the controller is adapted to send a recommendation signal indicative of the results of the comparison of the one or more identified contaminants with the manifest database.

In one embodiment, the recommendation signal is for display on a display device.

In one embodiment, the system further comprises a manifest database comprising manifest data of current and/or past potential contaminants that have been stored in or moved through the zone, the manifest database being operably coupled to the controller.

In one embodiment, the controller is adapted for logging on a logging database one or more selected from
a. the result of the comparison of the water quality parameters measured by the at least one or more water quality sensors to a contaminants database;
b. the results of the comparison of the identified contaminants with the manifest database;
c. the time at which the signals indicative of the water quality parameters were received.

In one embodiment, the controller is adapted for subtracting water quality parameters of an identified contaminant from water quality parameter signals received later in order to obtain subtracted water quality parameters.

In one embodiment, the controller is adapted for comparing the subtracted water quality parameters against the contaminants database to identify one or more subtracted contaminants.

In one embodiment, the the controller is adapted for comparing the subtracted contaminant with the manifest database.

In one embodiment, the controller is adapted for generating an alarm signal indicative of the subtracted contaminant.

In one embodiment, the controller is adapted for generating a recommendation signal indicative of the results of the comparison of the one or more identified subtracted contaminants with the manifest database.

In one embodiment, the system further comprises a fluid pressure sensor operably coupled to the controller and wherein, in use, the fluid pressure sensor is adapted to measure a fluid pressure at an inlet of the discharge valve.

In one embodiment, the controller is adapted to open the discharge valve upon determining the absence of at least one contaminant.

In one embodiment, in use, the controller is further configured to control the discharge valve to discharge a predetermined volume of water.

In one embodiment, the system further comprises a buffer tank fluidly coupled to an input of the discharge valve and wherein, in use, the controller is further configured to control the discharge valve to substantially discharge the contents of the buffer tank to the environment.

In one embodiment, the controller is adapted to receive a signal indicative of the level of the contents of one or more selected from the tank and the buffer tank.

In one embodiment, the system further comprises a rain sensor operably coupled to the controller and wherein, in use, the rain sensor is adapted to determine a rain event.

In one embodiment, the controller is adapted to generate an alarm signal in the event that a rise in the level of one or more selected from the tank and the buffer tank is detected without a corresponding detection of a rain event.

In one embodiment, the controller is adapted to initiate a sampling sequence of receiving water quality parameter measurements from said at least one or more water quality sensors, and comparing the water quality parameters measured by the at least one or more water quality sensors to a contaminants database.

In one embodiment, the sampling sequence further comprises comparing the identified contaminant to a manifest database.

In one embodiment, the controller is adapted to, upon detection of a rain event, open the discharge valve, and actuate a sampling sequence.

In one embodiment, the controller is adapted to, upon detection of a rain event and detection of a contaminant, close the discharge valve.

In one embodiment, the controller is adapted to control the discharge in accordance with the fluid pressure.

In one embodiment, the controller is adapted, in the event of the identification of a contaminant, to control a pump and valve system to discharge the contents of one or more selected from the buffer tank and the tank, to a waste water tank for further disposal.

In another aspect, the invention may be said to consist in a control system for identifying environmental spills and/or leakages at a protected zone, the control system comprising
a. a controller comprising
   1. a transmitter for transmitting signals;
   2. a receiver configured for receiving signals;
   3. digital media for storing control instructions; and
   4. a processor for processing the control instructions;
b. wherein the instructions are configured for directing the controller to receive signals indicative of water quality parameter measurements from at least one or more water quality sensors at the protected zone, the water quality sensors configured for making a water quality parameter measurement of a water quality parameter; and
c. wherein the instructions are configured for directing the controller to, in use, identify at least one contaminant in accordance with the water quality parameter measurement received from the water quality sensors.

A method of identifying environmental spills at a protected zone carried out on an electronic arrangement, the method comprising the steps of
a. receiving at least one or more signals indicative of water quality parameter measurements from at least one or more water quality sensors, the water quality sensors able to make a water quality parameter measurement of a water quality parameter; and
b. identifying at least one contaminant in accordance with the water quality parameter measurement received from the water quality sensors.

In one embodiment, the method further comprises the step of controlling a discharge valve, controlling discharge of run-off water at the protected zone, to the environment in accordance with the water quality parameter measurement.

In one embodiment, the method further comprises the step of comparing the water quality parameters measured by the at least one or more water quality sensors to a contaminants database of water quality parameters associated with known contaminants.

In one embodiment, the method further comprises the step of identifying at least one or more possible contaminants matching the water quality parameter measurements received from the sensors from the comparison of the water quality parameters with the contaminants database.

In one embodiment, the method further comprises the step of actuating an alarm signal in accordance with the comparison of the water quality parameter measurements with the contaminants database.

In one embodiment, the alarm signal includes an indication of the identified contaminant.

In one embodiment, the method further comprises the step of comparing the one or more identified contaminants with a manifest database of current and/or past potential contaminants that have been stored in or moved through the protected zone.

In one embodiment, the method further comprises the step of sending a recommendation signal indicative of the results of the comparison of the one or more identified contaminants with the manifest database.

In one embodiment, the method comprises displaying one or more selected from the alarm signal and the recommendation signal on a display.

In one embodiment, the method further comprises the step of logging on a logging database one or more selected from
a. the result of the comparison of the water quality parameters measured by the at least one or more water quality sensors to a contaminants database;
b. the results of the comparison of the identified contaminants with the manifest database;
c. the time at which the signals indicative of the water quality parameters were received.

In one embodiment, the method further comprises the step of subtracting water quality parameters of an identified contaminant from water quality parameter signals received later in order to obtain subtracted water quality parameters.

In one embodiment, the method further comprises the step of comparing the subtracted water quality parameters against the contaminants database to identify one or more subtracted contaminants.

In one embodiment, the method further comprises the step of comparing the subtracted contaminant with the manifest database.

In one embodiment, the method further comprises the step of generating an alarm signal indicative of the subtracted contaminant.

In one embodiment, the method further comprises the step of generating a recommendation signal indicative of the results of the comparison of the one or more identified subtracted contaminants with the manifest database.

In one embodiment, the method further comprises the step of measuring fluid pressure at an inlet of the discharge valve.

In one embodiment, the the method further comprises the step of opening the discharge valve upon determining the absence of at least one contaminant to discharge the run-off water to the environment.

In one embodiment, the method further comprises the step of receiving a signal indicative of the level of the run-off water in one or more selected from a tank and a buffer tank.

In one embodiment, the method further comprises the step of receiving a signal from a rain sensor indicative of a rain event.

In one embodiment, the method further comprises the step of generating an alarm signal in the event that a rise in the level of one or more selected from the tank and the buffer tank is detected without receiving a signal indicating a rain event.

In one embodiment, the method further comprises the step of initiating a sampling sequence of receiving water quality parameter measurements from said at least one or more water quality sensors, and comparing the water quality parameters measured by the at least one or more water quality sensors to a contaminants database.

In one embodiment, the sampling sequence further comprises the step of comparing the identified contaminant to a manifest database.

In one embodiment, the method further comprises the steps of, upon detection of a rain event, opening the discharge valve, and actuating a sampling sequence.

In one embodiment, the method further comprises the step of upon detection of a rain event and detection of a contaminant, closing the discharge valve.

In one embodiment, the method further comprises the step of controlling the discharge of the run-off water in accordance with a received fluid pressure signal.

In one embodiment, the method further comprises the step of, in the event of the identification of a contaminant, controlling a pump and valve system to discharge the contents of one or more selected from the buffer tank and the tank, to a waste water tank for further disposal.

To those skilled in the art to which the invention relates, many changes in construction and widely differing embodiments and applications of the invention will suggest themselves without departing from the scope of the invention as defined in the appended claims. The disclosures and the descriptions of the embodiments herein are purely illustrative and are not intended to be in any sense limiting.

In another aspect, the invention may be said to consist in an environmental protection system for protecting a protected zone from environmental spillsand/or leakages, the system comprising:
a. a controller operably coupled to the discharge valve, the controller able to control the discharge valve in use;
b. wherein the controller is configured for receiving signals indicative of water quality parameter measurements from at least one or more water quality sensors configured to sense the quality of the run-off water, the water quality sensors able to make a water quality parameter measurement of a water quality parameter;
c. wherein, in use, the controller is adapted to identify at least one contaminant in accordance with the water quality parameter measurements.

In one embodiment, the system further comprises a discharge valve for controlling the flow of run-off water from said protected zone into the environment.

In one embodiment, the controller is configured to control the discharge valve in accordance with the water quality parameter measurements received from the at least one or more water quality sensors

In one embodiment, the controller comprises
a. a transmitter for transmitting signals,
b. a receiver configured receiving signals,
c. digital media for storing control instructions, and
d. a processor for processing the control instructions;

In one embodiment, the discharge valve is configured for discharging water from a tank for storing water run-off from the protected zone.

Other aspects of the invention are also disclosed.

### BRIEF DESCRIPTION OF THE DRAWINGS

Notwithstanding any other forms which may fall within the scope of the present invention, a preferred embodiments of the invention will now be described, by way of example only, with reference to the accompanying drawings in which:

FIG. 1 shows a functional schematic of a system for environmental spills protection in accordance with a preferred embodiment of the present invention;

FIGS. 2 and 3 is shown exemplary physical apparatus implementation of the system of FIG. 1 in accordance with another embodiment of the present invention;

FIG. 4 shows an exemplary control narrative for the system of FIG. 1 in accordance with another embodiment of the present invention; and

FIGS. 5-7 show exemplary flow charts detailing the methods carried out by an environmental protection system.

### DESCRIPTION OF EMBODIMENTS

It should be noted in the following description that like or the same reference numerals in different embodiments denote the same or similar features.

### System 29 Overview

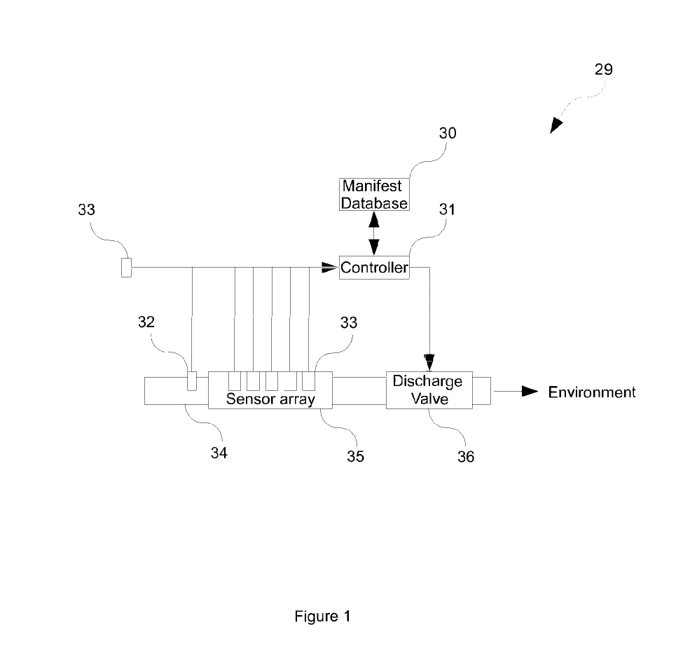

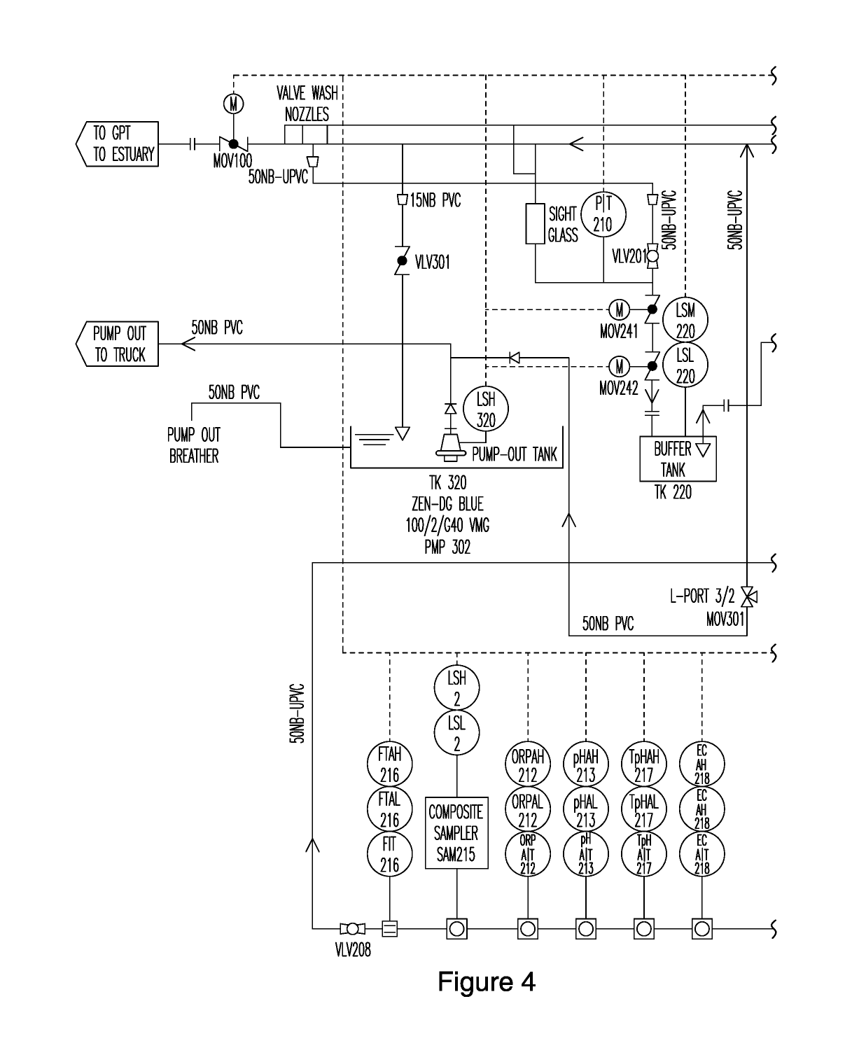

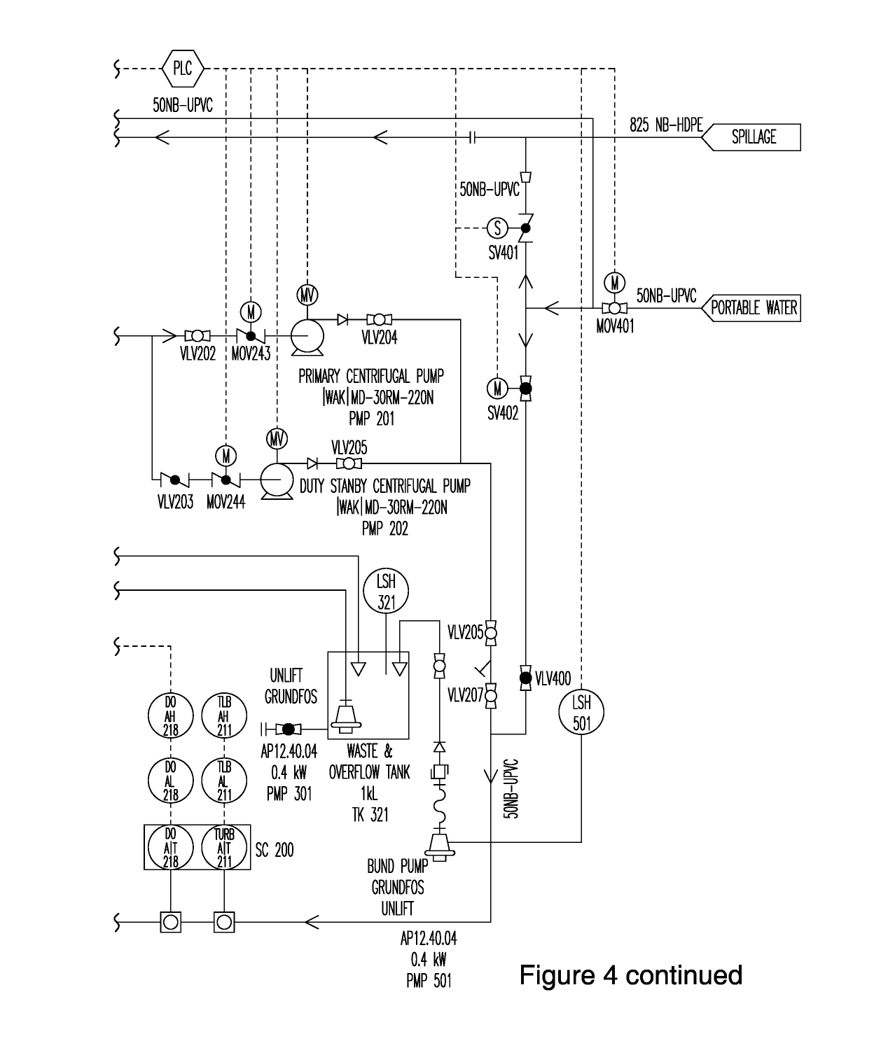

Referring to FIG. 1, there is shown a functional schematic of a system 29 for environmental spills protection. As will become apparent from the description below, the system 29 is adapted to monitor water discharge from a water run-off pipe (shown as line 825NB HDPE in FIG. 4) into the environment so as to be able to prevent contaminants, toxins and the like from being inadvertently released into the environment. The water run-off pipe is preferably 825 mm nominal bore in diameter and about a kilometre long. The water run-off pipe is large enough to function as a tank for storage of run-off water.

Discharge of run-off water from the water run-off pipe into the environment is controlled by discharge valve shown as MOV 100 in FIG. 4.

Specifically, in the exemplary embodiments described below, the system 29 will be described with reference to the application of using the system 29 to control the discharge of water into in an adjoining estuary collected from one or more gross pollutant traps at a protected zone such as a port facility or a rail facility. However, should be noted that no technical limitations should necessarily be imputed to the embodiments described herein in accordance with this exemplary embodiment. Specifically, terms used herein such as “water quality sensor” and the like are used for convenience only and the system 29 may be applicable for other applications adapted to prevent the unwanted release of other types of fluids, over and above those described herein.

The system 29 comprises a discharge valve 36 which is adapted to control the flow of water into the environment. As is evident, the discharge valve 36 is operably coupled to a main drainage line 34 so as to be to control the discharge of water from the main drainage line 34.

As alluded to above, the environment can, for example, be an estuary adjoining a port or rail facility or the like. As such, the main drainage line 34 may be fluidly coupled to one or more gross pollutant traps so as to collect spilled materials, stormwater and the like for release into the environment via the discharge valve 36.

The system 29 furthermore comprises a controller 31 operably coupled to the discharge valve 36. The controller 31 is able to control the discharge valve 36 in use by opening and closing the discharge valve 36.

Furthermore, the system 29 comprises at least one water quality sensor 33 operably coupled to the controller 31. As alluded to above, the term “water quality” should not be construed herein with any technical limitations in mind. Rather, the sensor 33 may be adapted to sense any kind of parameter for the purposes of use by the controller 31 for controlling the discharge valve 36.

Now, the at least one water quality sensor 33 is able to make a water quality parameter measurement of a water quality parameter at an input of the discharge valve 36. As such, in use, the controller 31 is adapted to control the discharge valve in accordance with the water quality parameter measurement measured by the at least one sensor 33. Specifically, if the controller 31 determines that the water quality meets certain water quality requirement then the controller 31 may deem the water safe for release into the environment and open the discharge valve 36.

The sensor 33 may be adapted to measure differing kinds of water quality parameters. However, in a preferred embodiment, the sensor 33 may measure at least one of pH, electrical conductivity/total dissolved solids, oxidation and reduction potential, turbidity, temperature, dissolved oxygen and total petrol hydrocarbons water quality parameters.

Specifically, referring to the table below, there is shown the various water quality parameters which may be measured by the sensor 33 including the abbreviation of the parameter and the detection limit of the parameter:

| | Description/ | |
|---|---|---|
| | Abbreviation/ | |
| Parameter | Units | Detection limit |
| pH | pH units | pH 0-14 |
| Electrical conductivity/Total | EC (mS)/TDS | 0.1 uS to |
| dissolved solids | (mg/L) | 500 mS/cm (mS) |
| Oxidation & reduction potential | ORP (mV) | −2000 to +2000 |
| | | (mV) |
| Turbidity | NTU | 0.001 to 100 NTU |
| Temperature | Celsius | −50 to +50 Celsius |
| Dissolved oxygen | DO (mg/L) | 0 to 12 (mg/L) |
| Total petroleum hydrocarbons | TPH (ppb) | 0.1 to 2000 (ppb) |
| Wastewater compozone sampler | Sampler (event | Sampler (event |
| | triggered) | triggered) |
| Rain sensor | on/off (indicator) | on/off (indicator) |

It should be noted that the sensor 33 may be adapted to measure other water quality parameters depending on the application. In one embodiment, the sensor 33 may comprise a spectrophotometer which may be adapted to monitor various water quality parameters. The use of the spectrophotometer to provide a greater accuracy in measurement especially advantageous for identifying contaminant compounds as will be described in further detail below.

Now, in one embodiment, the controller 31 is adapted to receive, from the sensor 33, a single water quality parameter measurement so as to be able to control the discharge valve 36 accordingly. However, in a preferred embodiment, and so as to reduce likelihood of error, the controller 31 is adapted to receive a plurality of water quality measurements from the at least one sensor 33. For example, the controller 31 can receive three water quality measurements from the at least one sensor 33 so as to only open the discharge valve 36 should every one of the water quality measurements indicate that the water is of sufficient quality to release into the environment. Now, in a preferred embodiment, the controller 31 is adapted to identify at least one contaminant in accordance with the water quality parameter measurement. It will be appreciated that if more water quality parameters are received, the system will be better able to identify particular contaminants.

In this regard, should be noted that the system 29 as substantially shown in FIG. 1 is exemplary only and that variations thereto may be made within the purposive scope of the embodiments described herein. Specifically, the controller 31 may take the form of a PLC device having limited computing power. As such, the identification of at least one contaminants may be made by another computing device (not shown) coupled to the controller 31 via a data network. In this manner, the other computing device may periodically retrieve, from the PLC controller 31 water quality measurement data so as to be able to identify the at least one contaminants.

Furthermore, it should be noted that the decision making process for the control of the discharge valve 36 need not necessarily be performed by the controller 31 (being guided by the software instructions) either. Rather, the decision as how to control the discharge valve 36 may be made by another computing device, especially in the embodiment where a potentially identify contaminants is cross-referenced to a manifest database (described in further detail below). A case, the other computing device should be regarded as being part of the controller.

However, in the exemplary embodiments described herein, the controller 31 is adapted to identify the at least one contaminants in accordance with the water quality parameter measurement.

For example, the controller 31 may be adapted to detect the presence of an insoluble powders in accordance with a turbidity measurement.

It should be noted that the system 29 is configured such that the default position of the discharge valve 36 is closed. Only upon the controller 31 determining the absence of at least one contaminant will the controller 31 open the discharge valve 36.

Furthermore, it should be noted that, in a preferred embodiment, the system 29 is configured to release set volumetric amounts of water into the environment or at least a measure the amount of water released into the environment. In this manner, should the system 29 fail to detect a particular type of contaminant, it may be ascertained the exact amount of this particular type of contaminant that has been released into the environment. Having such volumetric information on hand may advantageously be utilised for the purposes of cleanup operations and the like.

In one embodiment, the system 29 may comprise a flow meter or the like adapted to measure flow rate so as to be able to calculate a volumetric amount released into the environment. However, in another embodiment, the system 29 may comprise a buffer tank (not shown) which is, in an iterative manner, filled with water, sampled by the system 29, and, if found to meet the required water quality requirements, discharged into the environment.

Now, while above there was describe the controller 31 identifying at least one contaminant in accordance with a water quality measurement, in a preferred embodiment, the system 29 is adapted to measure a plurality of water quality measurements. In this regard, the system 29 is able to detect a larger number of potential contaminants.

As such, referring again to FIG. 1, the system 29 comprises a sensor array 35 comprising a plurality of sensors 33.

It is envisaged that initially the controller 31 will actuate or initiate a sampling sequence, which returns readings from the sensors 33 of water quality parameter measurements. The water quality parameter measurements received from the sensors 33 can then be compared against a range of acceptable water quality parameters to see if it falls within this range. If it does not, then the controller will interrogate a contaminants database to establish what contaminant(s) are in the water.

Alternately, the water quality parameter measurements need not be compared against the range of acceptable water quality parameters, and instead the water quality parameter measurements can be used to interrogate the contaminants database as part of each sampling sequence.

In a preferred embodiment, the sensor array 35 comprises eight sensors 33, each sensor 33 respectively adapted to measure pH, electrical conductivity/total dissolved solids, oxidation and reduction potential, turbidity, temperature, dissolved oxygen and total petrol hydrocarbons.

In this manner, the controller 31 is able to use a multivariable contaminant “fingerprint” of water quality measurements to provide a more accurate determination of a potential contaminant.

Specifically, referring to the exemplary table below, there is shown potential contaminants matching various water quality measurements:

| Contaminant group | Detection device | Limit of detection |
|---|---|---|
| Paint (water based) | turbidity | 0.001 to 100 NTU |
| | EC/TDS | 0.1 uS to 500 mS/cm (mS) |
| | DO | 0 to 12 (mg/L) |
| Paint (oil based) | turbidity | 0.001 to 100 NTU |
| | TPH | 0.1 to 2000 (ppb) |
| | EC/TDS | 0.1 uS to 500 mS/cm (mS) |
| Beverages (milk, wine) | turbidity | 0.001 to 100 NTU |
| | pH | pH 0-14 |
| | ORP | −2000 to +2000 mV |
| | DO | 0 to 12 (mg/L) |
| Volatiles | TPH | 0.1 to 2000 (ppb) |
| (hydrocarbons/solvents) | ORP | −2000 to +2000 mV |
| | EC/TDS | 0.1 uS to 500 mS/cm (mS) |
| | DO | 0 to 12 (mg/L) |
| Soluble powders | turbidity | 0.001 to 100 NTU |
| | pH | pH 0-14 |
| | EC/TDS | 0.1 uS to 500 mS/cm (mS) |
| Insoluble powders | turbidity | 0.001 to 100 NTU |

It should be noted that additional parameters obtained by experimental commissioning may be assessed by the controller 31.

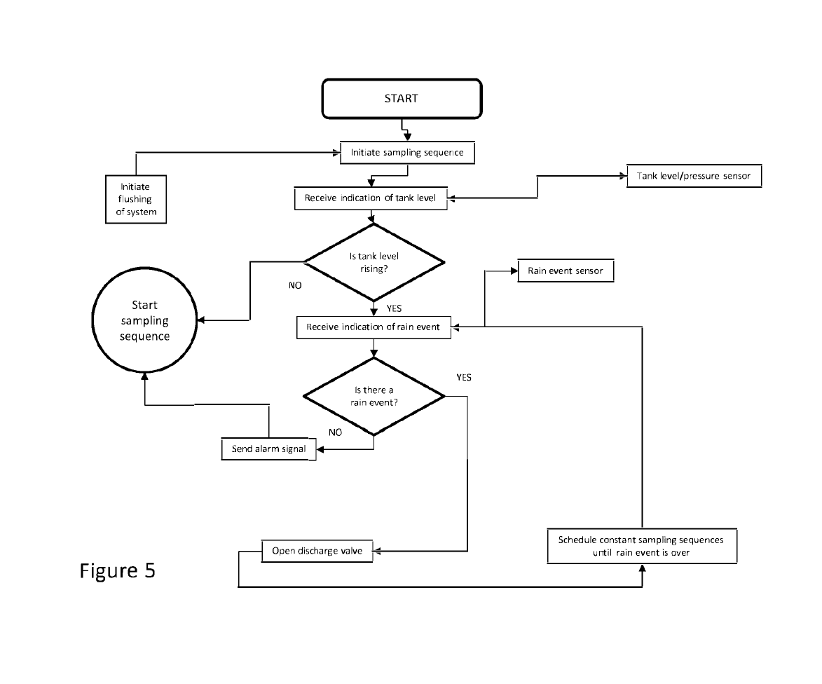

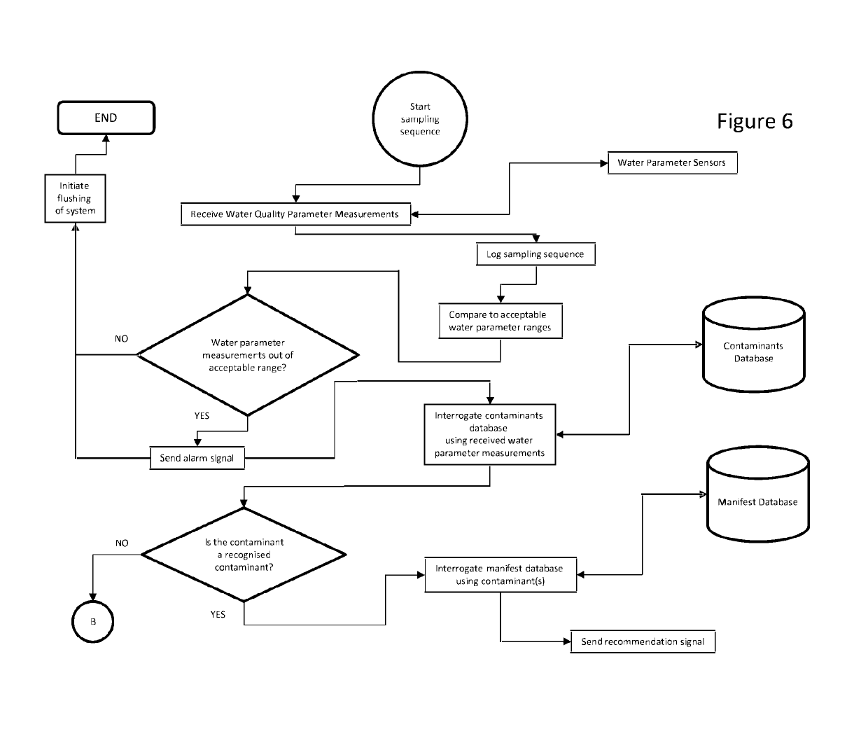

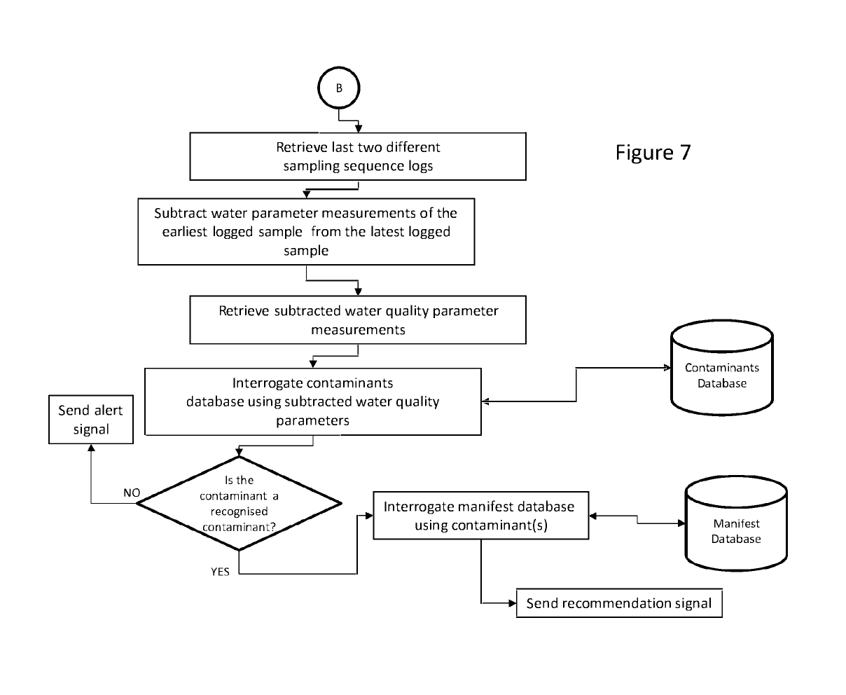

In this regard, it is anticipated that the system 29 will include a contaminant database (shown in FIG. 5) against which water quality parameter measurements received from the sensors can be compared in order to identify one or more probable contaminants.

Accordingly, the contaminant database will be interrogated by the controller using the received water quality parameter measurements to retrieve the probable contaminants.

Once the probable contaminants have been retrieved from the result of the comparison, an alert signal will be generated by the controller, preferably for display on a display device such as a screen (not shown), the alert signal preferably providing an indication of the probable contaminant.

As is evident from the above table, the controller 31 may detect water-based paint in accordance with the turbidity, electrical conductivity and dissolved oxygen water quality measurements, and so on and so forth.

Now, within the exemplary application described herein wherein the system 29 is adapted for controlling discharge of spill fluids, stormwater and the like from a port, the contents of containers entering a port are usually recorded within a manifest database. Specifically, the manifest database can comprise a record of the contents of each container currently stored at the protected zone, the location of each container and the like. It is anticipated that the manifest database can also comprise a record of past containers that have been stored or transported through the protected zone.

As such, the system 29 comprises a manifest database 30 or at least a database connection to an external manifest database. The controller will then compare the probable contaminants against those known to be stored or transported on-zone, or which were recently stored or transported on the protected zone.

Items on the manifest database matching the probable contaminants will then be matched, and the location and details of the cargo retrieved. The controller will then generate a recommendation signal giving an indication of the most likely source of the spill or leakage at the protected zone. In this manner, the system 29 may achieve greater accuracy in identifying a potential contaminant and location of the source on account of the candidates for potential contaminants being confined to those currently contained in containers in the port, or having recently left the port.

It will be appreciated that many logistics facilities nowadays are largely automated, and that any inspection or cleanup of leakages or spills may require a temporary shutdown of at least part of the facility. By identifying the most likely source of the spill or leakage, the system 29 can facilitate not only a quick reaction time to the spill or leakage, but also reduce the opportunity costs of searching for and cleaning the spill or leakage.

For example, should the controller 31 determine that, in accordance with the turbidity, pH, oxidation and reduction potential and dissolved oxygen, the potential contaminant is a beverage such as milk or wine, the controller 31 may subsequently retrieve, from the manifest database 30 the cargo manifest currently within the port. Should the cargo manifest show that one of the containers comprises a shipment of wine bottles from New Zealand, the controller 31 can exclude milk as being a potential contaminant, and send out a recommendation signal recommending that the cargo of wine be inspected first.

It should be noted that in certain embodiments of the cargo manifest may further comprise container numbers locations and the like such that should the controller 31 determine a particular type of contaminant, the exact location of the leaking container may be identified so as to quickly stem the leak.

In one embodiment, the system 29 further comprises a pressure sensor 32 operably coupled to the controller 31. In this manner, the pressure sensor 32 is able to measure a fluid pressure at an inlet of the discharge valve 36.

In this manner, the controller 31 may be adapted to control the discharge rate from the discharge valve 36 in accordance with the amount of water awaiting release as determined by the pressure. For example, should the controller 31 ascertain from the pressure sensor 32, that there is little or no pressure, such as during dry spells, the controller 31 may keep the discharge valve 36 closed. However, during a thunderstorm event, controller 31 may ascertain the buildup of stormwater awaiting release so as to initiate the sampling and discharge process in the manner described above.

It should be noted that the controller 31 may control the rate of release from the discharge valve 36 in substantial proportion with the pressure as measured by the pressure sensor 32. It should be noted that in certain embodiments, should the above preferred three sample process be too time-consuming in the event of a large build up of stormwater, the controller 31 may be adapted to reduce the number of samples even to a single sample so as to be able to cope with the demand.

In a further embodiment, the system 29 a further comprise a rain sensor 33 adapted to measure rainfall amount. In this manner, using the additional rainfall data is ascertained from the rental sensor 33, the controller 31 may take appropriate action to increase the rate of discharge from the discharge valve 36 even prior to receiving notification as to the buildup of stormwater from the pressure sensor 32.

It is envisaged that the controller will be configured to start a sampling sequence at regular intervals. It is envisaged that the rain sensor 33 can also be used in association with a pressure or level reading of the tank or buffer tank. For example where the rain sensor indicates that no rain event has been detected, but the level of the tank or buffer tank is increasing, then a sampling sequence can be started and an alert signal can be generated immediately as the most likely explanation is that there is a leak or spill.

Where a rain event is detected, and the discharge valve is required to be open to ensure that flooding does not occur, a more frequent (or constant) series of sampling sequences can be scheduled by the controller to ensure that no contaminated run-off water is discharged into the environment.

Where contaminant is detected during a rain event, the discharge valve will be closed and the run-off water stored within the large run-off pipe. This stored contaminated water can be diverted to a pump out tank (shown in FIG. 4) for removal by specialist contaminant cleaning operators.

It is anticipated that in exceptionally large port facilities, there is a higher probability of multiple leaks or spills. For this reason, it is anticipated that the system will be able to log the time and results of each sampling sequence. Where an initial sampling sequence results in the detection of a contaminant, and a later sampling sequence results in the detection of a contaminant which is not the same as the initial contaminant, it is anticipated that the water quality parameter measurements of the later sampling sequence could be caused by the summation of two separate leaks or spills. The later sampling sequence may not be able to match the water quality parameters against a known store contaminant from the contaminants database.

In such a case, it is envisaged that the earlier results from the sampling sequence could be subtracted or removed from the later results, leaving a subtracted water parameter measurement. This subtracted water parameter measurement could then be compared to stored contaminants in the contaminant database in order to establish what the contaminant was that spilled or leaked later than the first contaminant. If the subtracted water parameter measurement is also not recognised after being compared to the contaminants database, then a further alert signal may be generated making the relevant authorities aware of this.

Further, this later contaminant may also be compared to the manifest database to try and establish the nature and location of the spill or leakage.

In this regard, separate alert signals and/or recommendations signals can be generated, relating to each leakage or spill. In this way, multiple spills may be handled in larger facilities.

### Exemplary Apparatus

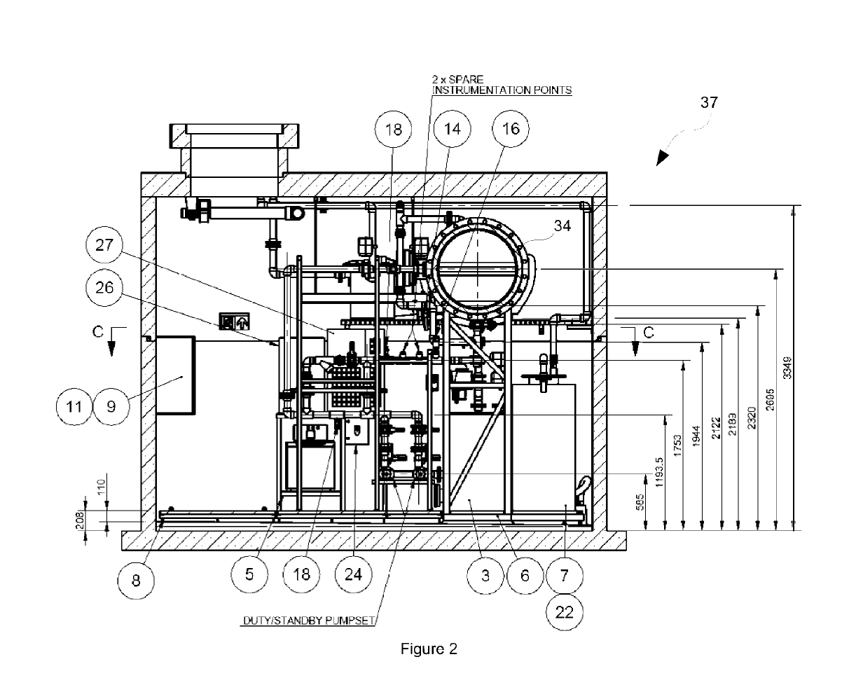

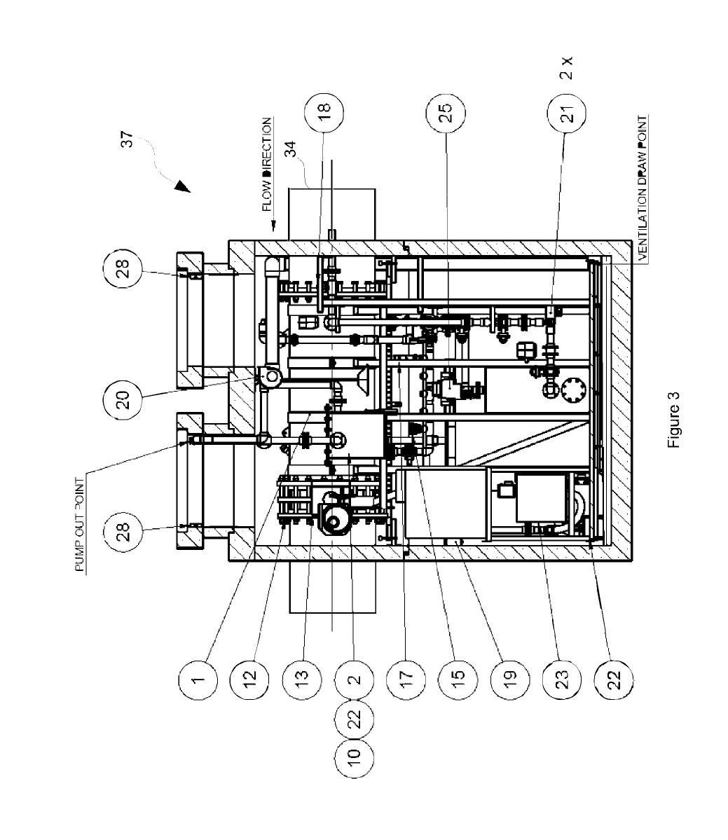

Reference is now made to FIGS. 2 and 3 showing an exemplary physical apparatus 37 embodiment of the system 29. It should be noted that the embodiment provided in these figures is exemplary only and that no technical limitations should necessarily be imputed to the embodiments described herein accordingly.

The items shown in FIGS. 2 and 3 are listed in the following table:

| ITEM | DESCRIPTION |
|---|---|
| 1 | PRIMARY MANIFOLD |
| 2 | PUMP SUMP |
| 3 | BUFFER TANK |
| 4 | SPILL CONTAINMENT PIT - FIXTURES |
| 5 | CENTER FLOOR GRID |
| 6 | PRIMARY MANIFOLD & VALVE SUPPORT STRUCTURE |
| 7 | WASTE & OVERFLOW TANK |
| 8 | SIMPLE FLOOR GRID |
| 9 | 1800 × 800 × 400 ELECTRICAL CABINET - LH |
| 10 | PUMP SUMP LID |
| 11 | 1800 × 800 × 400 ELECTRICAL CABINET - RH |
| 12 | BACKING RING JOINER |
| 13 | WEEG 800 TABLE E BUTTERFLY C/W ITQ6000 |
| 14 | BUTTERFLY VALVE TYPE 568 |
| 15 | INSERTION MAG FLOW METER |
| 16 | pH or ORP TRANSMITTER |
| 17 | pH or ORP TRANSMITTER |
| 18 | PRESSURE TRANSMITTER |
| 19 | OXYGEN MONITOR |
| 20 | 0.05 kW CENTRIFUGAL FAN |
| 21 | MAGNETIC DRIVE CENTRIFUGAL PUMP |
| 22 | SUBMERSIBLE DRAINAGE PUMP |
| 23 | WS700R REFRIGERATED WATER SAMPLER |
| 24 | 3 PHASE EXTERNAL MANUAL INTERLOCKING BYPASS |
| 25 | 1720E TURBIDIMETER |
| 26 | UPS BATTERY BOX |
| 27 | PSS M15kVA UPS |
| 28 | INDUCTIVE PROXIMITY SENSOR |

### Exemplary Control Narrative

Now, making reference to FIG. 4, there will be provided in the exemplary control narrative wherein the control of the system 29 will be provided as a very specific example. Again, the control narrative is exemplary only and no technical limitations should be imposed upon the embodiments described herein accordingly. Reference should be made to the accompanying appendices A to F.

The exemplary control narrative utilises the example of using a control system 29 within the application of a port to sample surface drainage water and stormwater such that if the surface drainage water and stormwater is within specification, allow the controlled discharge of the water into the environment.

Conversely, if the water is outside specification, then the discharge valve is to be closed and pipe contents to be pumped to an external reservoir. In event of any equipment or instrument fault the discharge valve is to default to close.

The main drainage line will normally have the main valve (MOV100) normally closed. It includes a pressure transducer to measure water height in the pipe. (PIT210)

### No Rain Event

When the level in the Main Line >10%, the Buffer tank (TK220) will be topped up by opening both valves MOV241 & MOV242 and gravity fed into the tank. The Float switch LSM220 with set dead band will control this function. Two valves are installed for reliability improvement. Position feedback on all valves is included to confirm operation.

### Sample Sequence 1:

From the Buffer tank 2×Sample pumps in Duty/standby configuration deliver a sample through the 8×sensors (FIT216, Sampler215, ORP212, pH213, TPH217, EC218, DO210, TURB211) and back to the Waste and Overflow Tank (TK321). When the Buffer Tank is full, further filling is to be inhibited until the end of each sampling sequence. This Duty Sample pump will run for 3 minutes, stop, then initiate a potable water flush through the sample line via MOV401 & SV402 for 1 minute. The sensor values for ORP212, pH213, TPH217, EC218, DO210, and TURB211 are to be logged at 170 secs after the start of the sample pump run period.

LSL220 in TK220 is low level protection backup for the sample pumps only.

Each sample pump is to have flow confirmation via FIT216. (>1 L/m after 30 s)

Duty/standby change over auto in event of low flow fault. Duty/Standby non cyclic, selection from HMI.

### Sample Sequence 2:

After the end of the potable water flushing cycle on Sample 1, start the refill of the Buffer tank and repeat the sample sequence until the end of the potable water flushing cycle.

### Sample Sequence 3:

After the end of the potable water flushing cycle on Sample 2, start the refill of the Buffer tank and repeat the sample sequence until the end of the potable water flushing cycle.

### Test Sequence:

If all 3 samples are within specifications for all sensors, then open discharge valve MOV100 to 10% to allow discharge.

At Main Line Level=10%, repeat sampling cycles and check for compliance. If OK maintain discharge cycle, if any of the 3 samples fail, initiate Alarm sequence.

Repeat this process at levels 9%, 8%, 7%, 6%, 4% &2%.

If all 3 samples are within specifications for all sensors then also pump out the Waste Tank (TK321) via 3 way valve MOV301 into the Main Line. LSH321 with set dead band will protect pump from dry running. The tank will always be pumped down after a full 3 cycle sample run either to Main Line or Pump out tank.

When the Main Line level < or =2%, initiate a potable water flush for the Main Line via MOV401 & SV401. The potable flush is to also fully open the discharge valve to 100%. When The Waste Tank is empty (LSH321=0) and Main Line Level=1%, close MOV100 to 0% and maintain potable flush for 2 minutes. System the reset to wait for Main Pipe level to rise to 11%.

Sampler (SAM215) is be initiated in event of a sample failure. Each initiate trigger is to be date/time stamped and recorded. LSH 210 is to raise an alarm in event of sample collection bottle high level.

Bund pump (PMP501) collects floor drainage and pumps into TK321. This pump has a compozone control float switch for control. Additionally LSH 501 is a backup level switch to raise an alarm in event of high level or pump failure.

Pump (PMP301) inside the waste & overflow tank, also with compozone control float switch, pumps discharged sample water back into the Main line via 3 way valve (MOV310) if there have been no sample failures, or into the pump out tank (TK320) if there has been a sample failure.

LSH321 is an additional high level float switch to monitor pump operation and level in TK321.

Pump out tank pump (PMP302) is used to discharge contaminated water outside to truck from TK320. This pump is to have a manual operation only driven from the HMI. LSH 320 is a backup float switch to alarm only.

Potable water is to be flushed through the sample line for 1 minute after each 2 min sample is taken via MOV401 & SV402.

Potable water is to flush the main pipe each time the main valve (MV100) has been opened to discharge, for 5 minutes via MOV401 and SV401.

### Rain Event

When the Main Line pipe level reaches 11%, initiate sample and discharge cycle as for No rain event. If the pipe level continues to rise, when it reaches 20% the valve position will fully modulate to maintain that 20% level with +/−1% deadband. When the pipe level lowers back to 11%, MOV100 will return to 10% open and continue the sample/discharge cycle as per no rain event.

Whenever the discharge valve is in modulation mode, sampling will be continuous.

Proximity switches are fitted to each of the 2 access hatches to activate the exhaust fan (EAF802) and lighting via MC11 when either of them is opened.

An oxygen monitor is connected to the PLC to alarm in event of LO O2 level.

### Appendix A—Instrumentation Legend

[symbol] TURBIDITY
[symbol] TURBIDITY ALARM LOW
[symbol] TURBIDITY ALARM HIGH
[symbol] pH UNITS (0-14)
[symbol] pH ALARM LOW
[symbol] pH ALARM HIGH
[symbol] PRESSURE TRANSMITTER
[symbol] PRESSURE TRANSMITTER ALARM LOW
[symbol] PRESSURE TRANSMITTER ALARM HIGH
[symbol] LEVEL INDICATOR TRANSMITTER
[symbol] LEVEL SWITCH LOW
[symbol] LEVEL SWITCH HIGH
[symbol] AMPERAGE DRAW
[symbol] OXIDATION REDUCTION POTENTIAL
[symbol] OXIDATION REDUCTION POTENTIAL ALARM LOW
[symbol] OXIDATION REDUCTION POTENTIAL ALARM HIGH
[symbol] TOTAL PETROLEUM HYDROCARBONS
[symbol] FLOW TRANSMITTER
[symbol] FLOW ALARM LOW
[symbol] FLOW ALARM HIGH
[symbol] MOTOR (FIXED SPEED)
[symbol] MOTOR (VARIABLE SPEED)
[symbol] COMPUTER FUNCTION
[symbol] SUBMERSIBLE PUMP
[symbol] FLOW METER
[symbol] CENTRIFUGAL PUMP
[symbol] BUTTERFLY VALVE NORMALLY OPEN
[symbol] BUTTERFLY VALVE NORMALLY CLOSED
[symbol] BALL VALVE NORMALLY OPEN
[symbol] BALL VALVE NORMALLY CLOSED
[symbol] REDUCER
[symbol] INSERTION TEE
[symbol] WATER LEVEL
[symbol] NON-RETURN VALVE
[symbol] EXHAUST FAN

### Appendix B—Instrumentation Schedule

MOV100—4-20 mA loop control for position control and feedback and open & closed position limit switches (Open=1, close=1), 0-100% operation takes 296 seconds.
Setpoints—no rain open position %, rain event open position target %
MOV302—Limit switch make for either direction feed. Operation time 35 s.
MOV 410/241/242/243/244—limit switch make for open & close position. Operation time 35 s.
SV401/402—NC energise to open
PIT210—4-20 mA loop, 0-1.6 bar. Set points 0%=×1 kPa, 100%=×2 kPA, target rain event level=×3%, rain event ×3% dead band level=×4%, no rain level target open=×5%, Pipe empty level=×6%,
DO210—4-20 mA loop, 0-20 mg/L, Set points—DO1=×1 mg/L, DO2H=×2 mg/L, DO3=×3 mg/L, DO4=×4 mg/L, DO5=×5 mg/L, DO6=×6 mg/L
TURB211—4-20 mA loop, 0-10 NTU. Set points TURB1=×1 NTU, TURB2=×1 NTU, TURB3=×3 NTU, TURB4=×4 NTU, TURB5=×5 NTU, TURB6=×6 NTU
ORP212—4-20 mA loop, −2000 to +2000 mV. Set point ORP1=×1 mV,
ORP2=×2 mV, ORP3=×3 mV, ORP4=×4 mV, ORP5=×5 mV, ORP6=×6 mV
pH213—4-20 mA loop, 0-14. Set points pH1=×1 pH units, pH2=×2 pH units, pH3=×3 pH units, pH4=×4 pH units, pH5=×5 pH units, pH6=×6 pH units
FIT216—4-20 mA loop, 0-100 L/min. Set points—inhibit time=×secs, min flow setting=×L/min
TPH217—4-20 mA 0-20000 ppm. Set points TPH1=×1 ppm, TPH2=×2 ppm, TPH3=×3 ppm, TPH4=ppm, TPH5=×5 ppm, TPH6=×6 ppm
EC218—4-20 mA, 0-10000 microS. Setpoints EC1=×1 microS, EC2=×2 microS, EC3=×3 microS, EC4=×4 microS, EC5=×5 microS, EC6=×6 microS
AIT803—4-20 mA, 0-25%. Set points—O2 H=×1%, 02 L=×2%, 02 LL=×3%

All valves to have position confirmation open/close. In event of failure activate close position of valve and raise alarm.

All 4-20 mA instruments to have broken wire detection and out of range indication (2 mA<Flt<3.8 mA & 20.2 mA<Flt<22 mA). These are to be alarm conditions only.

### Appendix C Water Sample Criteria Logic for FIG. 4

Water Sample C1=DO1 OR TURB1 OR ORP1 OR pH1 OR EC1 OR TPH1
Water Sample C2=DO2 OR TURB2 OR ORP2 OR Ph2 OR EC2 OR TPH2
Water Sample C3=DO3 OR TURB3 OR ORP3 OR pH3 OR EC3 OR TPH3
Water Sample C4=DO4 OR TURB4 OR ORP4 OR pH4 OR EC4 OR TPH4
Water Sample C5=DO5 OR TURB5 OR ORP5 OR pH5 OR EC5 OR TPH5
Water Sample C6=DO6 OR TURB6 OR ORP6 OR pH6 OR EC6 OR TPH6

### Appendix C Alarm Conditions for FIG. 4

Main line pipe level >75%
Main Line valve fail to close
Bund pump HH level—LSH501
Waste Tank HH level—LSH321
Pump out Tank HH level—LSH320
Rain Event—DI900
3 way valve fail to make main pipe limit
3 way valve fail to make pump out tank limit
MOV241 fail to open
MOV241 fail to close
MOV242 fail to open
MOV242 fail to close
MOV243 fail to open
MOV243 fail to close
MOV244 fail to open
MOV244 fail to close
MOV401 fail to open
MOV401 fail to close
Sump Pump overload
Pump out Tank overload
Waste Tank pump overload
Duty sample pump low flow
Standby sample pump low flow
Sampler level HH—LSH215
Water Sample C1 fail
Water Sample C2 fail
Water Sample C3 fail
Water Sample C4 fail
Water Sample C5 fail
Water Sample C6 fail
UPS in Bypass
Single Phase supply fail
Three phase supply fail
UPS healthy
MCC Stop operated
Instrument Fault (common)

### Appendix D SMS Dialler Alarms

Critical Alarm to include all of the following:
Single Phase supply fail
Three phase supply fail
Water Sample C1 fail
Water Sample C2 fail
Water Sample C3 fail
Water Sample C4 fail
Water Sample C5 fail
Water Sample C6 fail
Main line pipe level >75%
Main Line valve fail to close
Bund pump HH level—LSH501
Waste Tank HH level—LSH321
Pump out Tank HH level—LSH320
Rain Event—DI900
Standby sample pump low flow
Sump Pump overload
Pump out Tank overload
Waste Tank pump overload
MOV241 fail to close
MOV242 fail to close
MOV243 fail to close
MOV244 fail to close
MOV401 fail to close
3 way valve fail to make main pipe limit
3 way valve fail to make pump out tank limit

Non Critical Alarm to include all of the following:
UPS in Bypass
MCC Stop operated
Duty sample pump low flow
Sampler level HH—LSH215
MOV241 fail to open
MOV242 fail to open
MOV243 fail to open
MOV244 fail to open
MOV401 fail to open

### Appendix E HMI

All alarms to be value, time & date stamped & and recorded on accessible database available thru HMI ad to include 2 months data, then overwrite oldest data. Records to be able to be uploaded via VPN Ethernet port.

All alarms to be acknowledged through HMI Separate page(s) to allow access to adjust set points, with security access.

All analogue HI/LO alarm setpoints, level controls, flow settings and inhibit and operate timers.

Include a PFD representation as a main screen then drill down to more detail on other screens

Any condition preventing normal function is to be displayed on screens.

Man override pads for sump pump (MC3), lighting (MC11) and waste tank pump (MC13) to include.

PMP302 (pump out tank) to have manual control pad on screen.

Data logs to include to constant recordings of ORP, pH, EC, DO, TURB, TPH whenever either sample pump is running, all parameters on a time base log of 2 seconds and to hold 2 months data, then overwrite oldest data. Records database to be able to be uploaded through VPN Ethernet port.

### Appendix F Communications

Projects to have software setup for VPN remote access to PLC & HMI for up/download and remote monitoring.

Ability to upload data logs remotely.

### Interpretation

### Markush Groups

In addition, where features or aspects of the invention are described in terms of Markush groups, those skilled in the art will recognise that the invention is also thereby described in terms of any individual member or subgroup of members of the Markush group.

### Chronological Sequence

For the purpose of this specification, where method steps are described in sequence, the sequence does not necessarily mean that the steps are to be carried out in chronological order in that sequence, unless there is no other logical manner of interpreting the sequence.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the environmental control system industries.

1. An environmental protection system for detecting spills and/or leakages at a zone, the system comprising:
a) a controller operably coupled to the discharge valve, the controller able to control the discharge valve in use;
b) wherein the controller is configured for receiving signals indicative of water quality parameter measurements from at least one or more water quality sensors configured to sense the quality of run-off water from the zone, the water quality sensors able to make a water quality parameter measurement of a water quality parameter;
c) wherein, in use, the controller is adapted to identify at least one contaminant in accordance with the water quality parameter measurements.

2. The system as claimed in claim 1, wherein the system further comprises a discharge valve for controlling the flow of run-off water from said zone into the environment.

3. The system as claimed in claim 2, wherein the controller is configured to control the discharge valve in accordance with the water quality parameter measurements received from the at least one or more water quality sensors

4. The system as claimed in claim 3, wherein the controller comprises
i) a transmitter for transmitting signals,
ii) a receiver configured receiving signals,
iii) digital media for storing control instructions, and
iv) a processor for processing the control instructions.

5. The system as claimed in claim 4, wherein the discharge valve is configured for discharging water from a tank for storing water run-off from the zone.

6. The system as claimed in claim 5, wherein the system further comprises at least one or more water quality sensors operably coupled to the controller, the at least one water quality sensor being able to make a water quality parameter measurement of a water quality parameter.

7. The system as claimed in claim 6, wherein the at least one water quality sensor is a plurality of water quality sensors each respectively able to sense a plurality of water quality parameter measurements and wherein, in use, the controller is adapted to identify the at least one contaminant in accordance with the plurality of water quality parameter measurements.

8. The system as claimed in claim 7, further comprising a contaminants database of stored contaminants associated with known water quality parameters or ranges of water quality parameters.

9. The system as claimed in claim 8, wherein the controller is adapted to compare the water quality parameters measured by the at least one or more water quality sensors to a contaminants database of water quality parameters associated with known contaminants.

10. The system as claimed in claim 9, wherein the controller is adapted to identify at least one or more possible contaminants matching the water quality parameters measurements received from the sensors from the comparison of the water quality parameters with the contaminants database.

11. The system as claimed in claim 10, wherein the controller is adapted to actuate an alarm signal in accordance with the comparison.

12. The system as claimed in claim 11, wherein the alarm signal includes an indication of the identified contaminant.

13. The system as claimed in claim 12, wherein the at least one or more sensors are configured for detecting water quality parameters including at least one or more selected from pH, electrical conductivity/total dissolved solids, oxidation and reduction potential, turbidity, temperature, dissolved oxygen, total petrol hydrocarbons water quality parameter measurements.

14. The system as claimed in claim 13, wherein the controller is adapted to control the discharge valve in accordance with the comparison of the water quality parameters with the contaminants database.

15. The system as claimed in claim 14, wherein the controller is adapted to compare the one or more identified contaminants with a manifest database of current and/or past potential contaminants that have been stored in or moved through the zone.

16. The system as claimed in claim 15, further comprising a manifest database including manifest data of current and/or past potential contaminants that have been stored in or moved through the zone, the manifest database being operably coupled to the controller. combine

17. The system as claimed in claim 16, wherein the controller is adapted to send a recommendation signal indicative of the results of the comparison of the one or more identified contaminants with the manifest database.

18. The system as claimed in claim 17, wherein the recommendation signal is for display on a display device.

19.-39. (canceled)

40. A control system for identifying environmental spills at a zone, the control system comprising
a) a controller comprising
i) a transmitter for transmitting signals;
ii) a receiver configured for receiving signals,
iii) digital media for storing control instructions; and
iv) a processor for processing the control instructions;
b) wherein the instructions are configured for directing the controller to receive signals indicative of water quality parameter measurements from at least one or more water quality sensors, the water quality sensors configured for making a water quality parameter measurement of a water quality parameter; and
c) wherein the instructions are configured for directing the controller to, in use, identify at least one contaminant in accordance with the water quality parameter measurement received from the water quality sensors.

41. A method of identifying environmental spills at a zone carried out on an electronic arrangement, the method comprising the steps of
a) receiving at least one or more signals indicative of water quality parameter measurements from at least one or more water quality sensors, the water quality sensors able to make a water quality parameter measurement of a water quality parameter; and
b) identifying at least one contaminant in accordance with the water quality parameter measurement received from the water quality sensors.

42.-64. (canceled)
